(19) United States
(12) Patent Application Publication
(10) Pub. No.: US 2019/0293225 A1
(43) Pub. Date: Sep. 26, 2019

(54) SYSTEM AND METHOD FOR REPAIR OF UNDERGROUND PIPES USING WATER INFILTRATION

(71) Applicant: Edward Thomas Richards, JR., El Dorado Hills, CA (US)

(72) Inventor: Edward Thomas Richards, JR., El Dorado Hills, CA (US)

(21) Appl. No.: 15/928,890

(22) Filed: Mar. 22, 2018

(51) Int. Cl. F16L 55/168; F16L 55/18

(52) U.S. Cl. CPC F16L 55/1683; F16L 55/18

(57) ABSTRACT

A system and method for repair of underground pipes using water infiltration are disclosed. An example embodiment includes: a probe with a hollow interior, the probe having a receiving end and a probe tip; a pressurized infiltration liquid provider to source infiltration liquid; a viscous sealant supply to provide viscous sealant; a manifold coupled to the receiving end of the probe, the manifold also being coupled to the pressurized infiltration liquid provider and the a viscous sealant supply; the pressurized infiltration liquid provider being configured to eject infiltration liquid through the manifold, into the hollow interior of the probe, and out of the probe tip; and the viscous sealant supply being configured to eject viscous sealant through the manifold, into the hollow interior of the probe, and out of the probe tip.

### TECHNICAL FIELD

The disclosed subject matter relates to the field of pipes, pipelines, sewers, water mains, conduit, and other passageway technology, and particularly to the repair of underground pipes using water infiltration.

### COPYRIGHT

A portion of the disclosure of this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure provided herein and to the drawings that form a part of this document: Copyright 2017-2018, Edward Thomas Richards, Jr., All Rights Reserved.

### BACKGROUND

Conventional technologies provide numerous systems and methods to repair and maintain pipes, pipelines, sewers, conduits, and passageways from the inside in order to restore the integrity of these pipeline systems. However, it is often necessary to perform in situ repair or rehabilitation of underground pipeline systems from the outside or externally to the pipe; because, the internal pipeline system infrastructure may not permit a sufficient level of access or the repair is only possible from the outside of the pipe. Additionally, it may not be practical or cost-effective to dig down to a problem area of a pipe. Older underground pipeline systems can encounter a variety of problems over time. Cracks, breakage, leaks, joint separations, and the like can occur in conventional underground pipeline systems. Soil subsidence in the area around an underground pipe can weaken the support structure of the pipe and cause breakage or sagging of an underground pipe. Conventional techniques are unable to repair these problems with underground pipeline systems.

### SUMMARY

A system and method for repair of underground pipes using water infiltration are disclosed. An example embodiment includes: a probe with a hollow interior, the probe having a receiving end and a probe tip; a pressurized infiltration liquid provider to source infiltration liquid; a viscous sealant supply to provide viscous sealant; a manifold coupled to the receiving end of the probe, the manifold also being coupled to the pressurized infiltration liquid provider and the a viscous sealant supply; the pressurized infiltration liquid provider being configured to eject infiltration liquid through the manifold, into the hollow interior of the probe, and out of the probe tip; and the viscous sealant supply being configured to eject viscous sealant through the manifold, into the hollow interior of the probe, and out of the probe tip.

Another example embodiment includes a method comprising: providing a probe with a hollow interior, the probe having a receiving end and a probe tip; providing a pressurized infiltration liquid provider to source infiltration liquid; providing a viscous sealant supply to provide viscous sealant; coupling a manifold to the receiving end of the probe; coupling the manifold to the pressurized infiltration liquid provider and the viscous sealant supply; using the pressurized infiltration liquid provider to eject infiltration liquid through the manifold, into the hollow interior of the probe, and out of the probe tip; and using the viscous sealant supply to eject viscous sealant through the manifold, into the hollow interior of the probe, and out of the probe tip.

### BRIEF DESCRIPTION OF THE DRAWINGS

Embodiments are illustrated by way of example and not limitation in the figures of the accompanying drawings, in which:

FIGS. 1 and 2 illustrate an external underground pipe repair system of an example embodiment;

FIGS. 3 through 5 illustrate a hollow drill bit that can be used with the external underground pipe repair system of an example embodiment; and

FIG. 6 illustrates a flow diagram representing a sequence of operations performed in a method according to an example embodiment.

### DETAILED DESCRIPTION

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

According to various example embodiments of the disclosed subject matter as described herein, there is disclosed, illustrated, and claimed a system and method for the external repair of underground pipes using water infiltration. The example embodiments disclosed herein provide an apparatus, system, and method implemented as an external underground pipe repair system, which can be used in a variety of applications including servicing underground pipelines. In the various embodiments, the pipes or pipelines as denoted herein can include conventional pipes, piping, pipelines, sewer or sewage lines, water mains, drain lines, and other types of pipelines. These pipelines can be fabricated from a variety of materials including metal, polyvinyl chloride (PVC) or other plastics, composite materials, ceramic, fiberglass, or concrete. In an example embodiment, the external underground pipe repair system as described herein can operate externally to pipes of a diameter from a few centimeters to several meters. The example embodiments provide a system and method for in situ maintenance and external repair of various types and sizes of pipes and pipeline networks. The example embodiments can be used with pipeline arrangements with bends, turns, angles, curves, or reduced diameter segments. The example embodiments are designed to provide access to particular pipe locations from the outside or externally to the pipe through concrete, asphalt, layers of dirt, and/or other intervening matter under which the particular pipe is located. A probe, as part of the external underground pipe repair system, enables the external underground pipe repair system to use mechanical drilling, coring, and liquid infiltration to move through the intervening matter and position the probe tip adjacent to an underground pipe portion to be repaired. A viscous sealant can be injected into a receiving end of the probe and ejected through the probe tip underground and adjacent to a leak, crack, or other problem area of the pipe being repaired or maintained. The sealant can adhere to the pipe and seal any leaks or cracks in the pipe. A catalyst in the viscous sealant can be configured to cause the sealant to harden into a rigid, semi-rigid, foam-like, or rubber-like material with water-resistant and corrosion-resistant properties. As a result, the leak, crack, or other problem area of the pipe is repaired externally to the pipe and without excavating or exposing the pipe from its underground location. A detailed description of various example embodiments of the system and method is provided below.

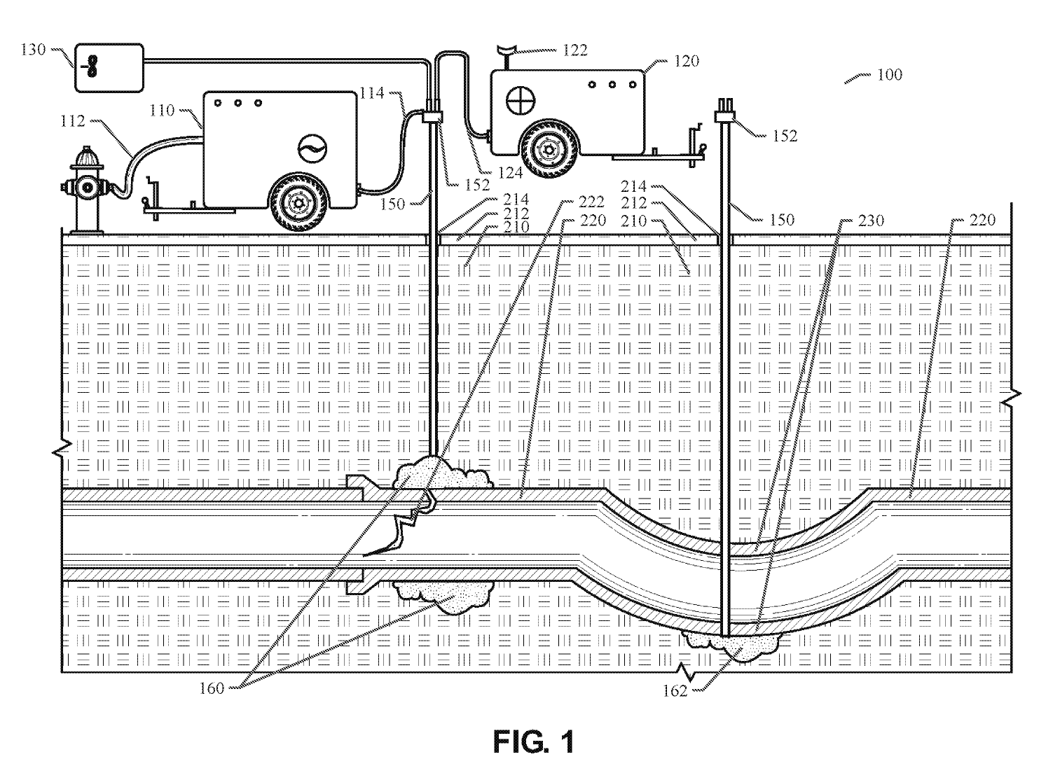

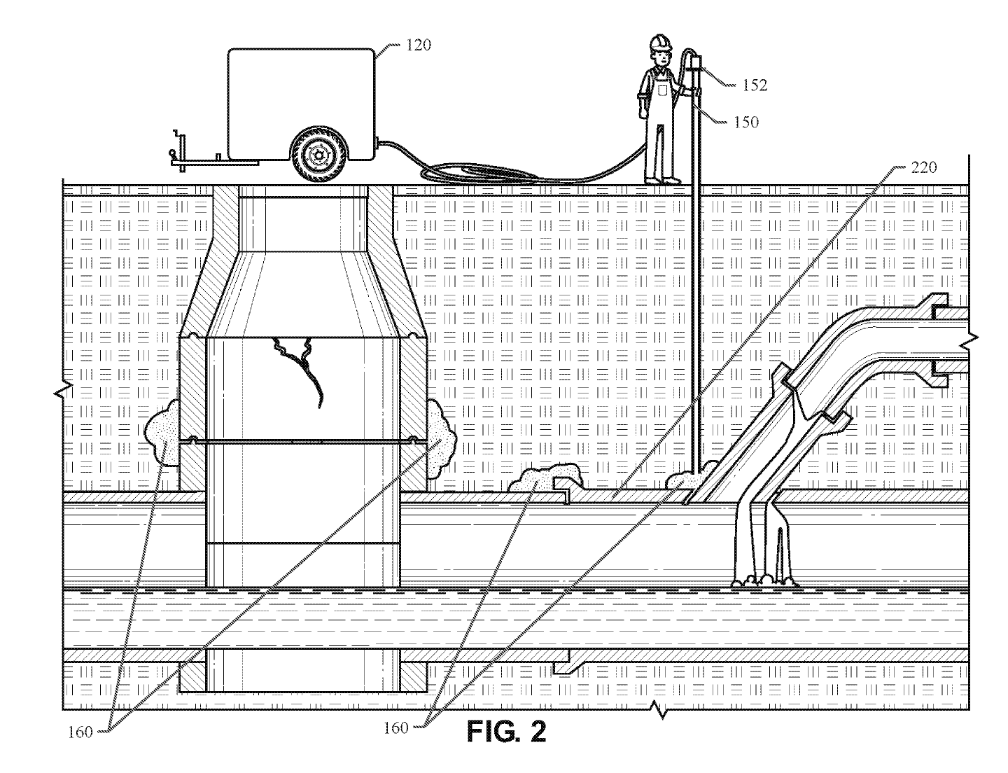

Referring now to FIGS. 1 and 2, example embodiments of the external underground pipe repair system 100 are illustrated. FIG. 1 illustrates an example embodiment of the external underground pipe repair system 100, which can be configured to include a probe 150 and a manifold 152 attached to a receiving end of the probe 150 above ground. The probe 150 can be a cylindrical, hollow, metal or rigid tube, which can be implemented in attachable segments or telescoping segments. The probe 150 can be configured to deliver infiltration liquid (e.g., water), viscous sealant, and pressurized air through the hollow interior of the probe 150 to a probe tip below ground level.

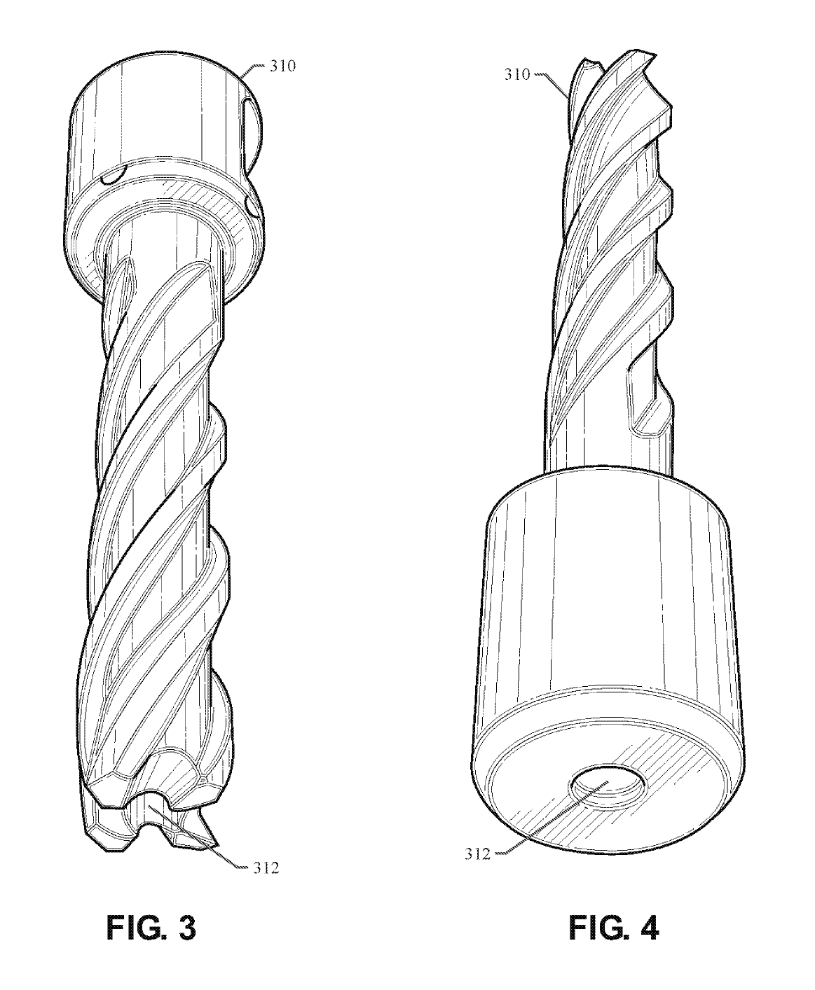

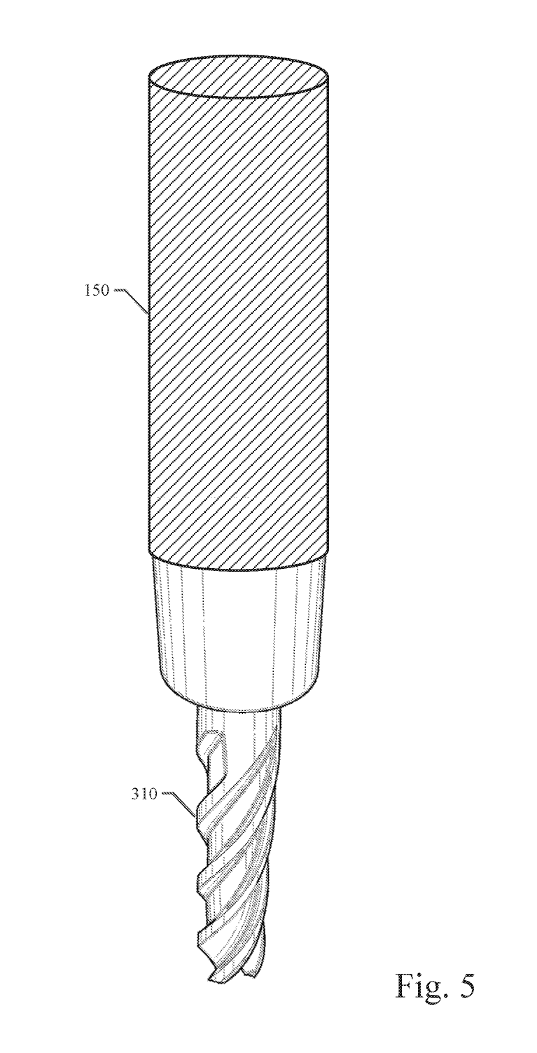

FIGS. 3 through 5 illustrate a hollow drill bit 310 that can be used with the external underground pipe repair system 100 of an example embodiment. As shown in FIGS. 3 and 4, the drill bit 310 can be configured with a hollow center 312 through which the infiltration liquid (e.g., water), viscous sealant, and pressurized air can be delivered at the probe tip below ground level. FIG. 5 illustrates an example embodiment where the hollow drill bit 310 can be attached to the probe 150 to form the probe tip. In the example embodiment, the probe 150 with the attached hollow drill bit 310 can be configured to turn about a vertical axis thereby causing the hollow drill bit 310 to drill into the intervening layers of material between ground level and a point below ground where a portion of underground pipe requires repair. In other embodiments, the probe 150 can be used without the hollow drill bit 310 attached at the probe tip. In these embodiments, the pressurized infiltration liquid can be ejected from the probe tip to enable the probe 150 to descend through the intervening layers of material between ground level and a point below ground where a portion of underground pipe requires repair. This embodiment is useful in situations where undetected underground wires or gas lines could be ruptured by use of a mechanical drilling tool. In other embodiments, the hollow drill bit 310 providing mechanical drilling can be used in combination with the ejection of pressurized infiltration liquid to cause the probe 150 to descend through the intervening layers of material between ground level and a point below ground where a portion of underground pipe requires repair.

Referring again to FIG. 1, the external underground pipe repair system 100 can be configured to include a pressurized infiltration liquid provider 110, a viscous sealant supply 120, and a pressurized air source 130. The pressurized infiltration liquid provider 110 can source infiltration liquid (e.g. water) from a nearby hydrant via a hose 112. The pressurized infiltration liquid provider 110 can include a reservoir tank for storing the infiltration liquid. The pressurized infiltration liquid provider 110 can pressurize the infiltration liquid to a configurable pressure level and eject the infiltration liquid into an intake port on manifold 152 via hose 114. As described above, the manifold 152 can be attached to a receiving end of the probe 150 above ground. The manifold 152 enables the pressurized infiltration liquid sourced from the pressurized infiltration liquid provider 110 to be forced into the hollow interior of the probe 150 and out through the probe tip. The action of the pressurized infiltration liquid expelled from the probe tip serves to eject material from the intervening ground layers and enable the probe 150 to be driven down through the intervening ground layers toward a desired location adjacent to a portion of an underground pipe in need of repair.

In a similar fashion, the pressurized air source 130 can pressurize environmental air to a configurable pressure level and eject the pressurized air into a second intake port on manifold 152. The manifold 152 enables the pressurized air sourced from the pressurized air source 130 to be forced into the hollow interior of the probe 150 and out through the probe tip. The action of the pressurized air expelled from the probe tip serves to further eject liquid and material from the intervening ground layers and to dry the underground area adjacent to the probe tip. Valves provided on the manifold 152 enable an operator to selectively enable or disable the flow of liquid or air into the hollow interior of the probe 150.

Using the hollow drill bit 310, the pressurized infiltration liquid provider 110, and/or the pressurized air source 130, an operator can use the probe 150 to penetrate into the intervening layers of material between ground level and a point below ground where a portion of underground pipe requires repair. For example, as shown in FIG. 1, a top layer of asphalt or concrete 212 can be penetrated to create a hole 214 exposing the dirt layers 210 below the top layer of asphalt or concrete 212. A standard concrete saw or coring machine can be used to create the hole 214 in the top layer of asphalt or concrete 212. Then, the probe 150 can be inserted into the hole 214 and the hollow drill bit 310, the pressurized infiltration liquid provider 110, and/or the pressurized air source 130, can be used to penetrate into the intervening layers of material 210 between ground level and a point below ground where a portion of underground pipe 220 requires repair. For example, as shown in FIG. 1, the probe tip of probe 150 can be positioned adjacent to a crack or leak 222 in pipe 220. Similarly, the probe tip of probe 150 can be positioned adjacent to or underneath a sag or belly 230 in pipe 220.

Once the probe tip of probe 150 is positioned adjacent to an underground pipe requiring repair as described above, the viscous sealant supply 120 can be used to deliver viscous sealant to the portion of the pipe in need of repair. Referring again to FIG. 1, the viscous sealant supply 120 can include a hopper 122 into which a supply of raw pipe sealant can be poured or placed. The viscous sealant supply 120 can include a reservoir tank for storing the viscous sealant. In an example embodiment, the sealant can be silicone foam, synthetic rubber, viscous adhesive material, or other viscous material that can seal and/or expand after drying. Such sealants are well-known in the art. Some sealants can be configured with a catalyst additive that can cause the sealant to dry, harden, and/or expand after a pre-determined time period. The viscous sealant supply 120 can pressurize the raw sealant added to the hopper 122 to a configurable pressure level and eject the pressurized sealant into a third intake port on manifold 152 via hose 124. The manifold 152 enables the pressurized sealant sourced from the viscous sealant supply 120 to be forced into the hollow interior of the probe 150 and out through the probe tip. A valve provided on the manifold 152 enables an operator to selectively enable or disable the flow of viscous sealant into the hollow interior of the probe 150. The viscous sealant supply 120 can also enable an operator to add a catalyst to the viscous sealant prior to the ejection of the pressurized sealant into the third intake port on manifold 152.

As a result, the sealant can be delivered in a liquid or viscous form through the probe 150 after which the sealant can dry, harden, expand, or otherwise cure after a pre-determined time period. As shown on FIG. 1, the sealant 160 can be delivered underground adjacent to or underneath a crack or break 222 or a sag 230 in pipe 220. The fluid sealant can seep into the crack or break 222 in pipe 220. Once the sealant 160 cures, the crack or break 222 in pipe 220 can be repaired externally to the pipe 220 as described herein. Additionally, the expanding sealant 162 can serve to lift a sag 230 in pipe 220 and/or prevent further sagging of a pipe caused by soil subsidence. In this manner, the external underground pipe repair system 100 of an example embodiment provides an efficient way to repair several types of problems with underground pipes without excavating or exposing the pipe from its underground location.

FIG. 2 illustrates another example embodiment of the external underground pipe repair system 100, which includes the probe 150 and the manifold 152 attached to a receiving end of the probe 150 above ground. As described above, the operator can use the viscous sealant supply 120 to inject the pressurized sealant sourced from the viscous sealant supply 120 through manifold 152 into the hollow interior of the probe 150 and out through the probe tip. As described above, the probe 150 can be positioned adjacent to pipes 220 in need of repair. As shown on FIG. 2, the sealant 160 can be delivered underground adjacent to joints or seams in pipe 220. The fluid sealant can seep into the joints or seams in pipe 220. Once the sealant 160 cures, the joints or seams in pipe 220 can be maintained or repaired externally to the pipe 220 as described herein. Thus, the external underground pipe repair system 100 of an example embodiment is disclosed.

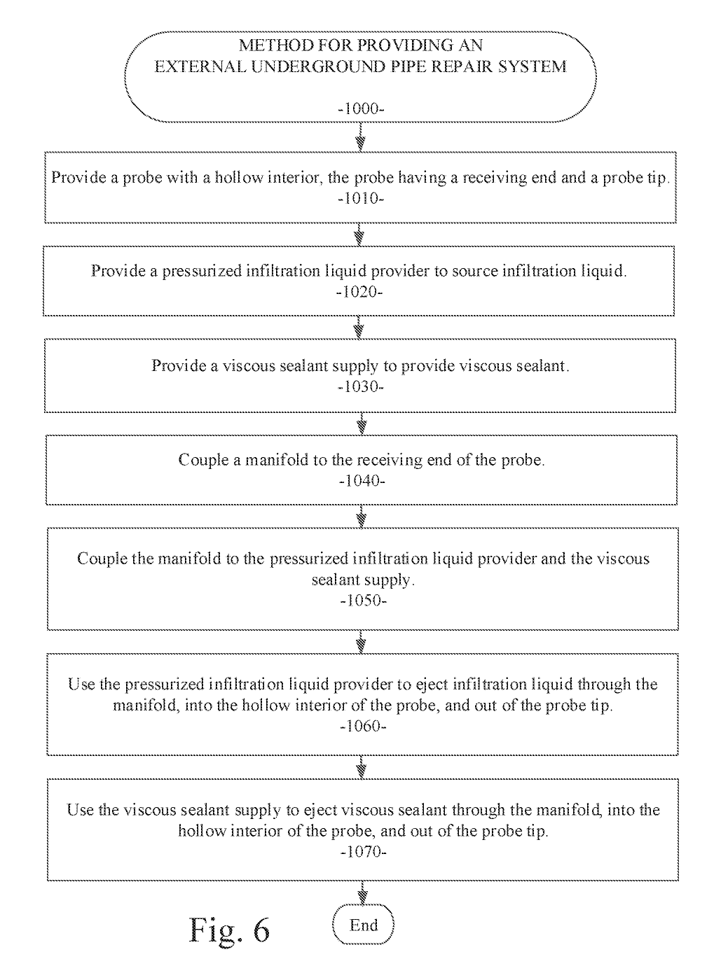

FIG. 6 illustrates a flow diagram representing a sequence of operations performed in a method according to an example embodiment. In accordance with the example method 1000, the method comprises: providing a probe with a hollow interior, the probe having a receiving end and a probe tip (operation 1010); providing a pressurized infiltration liquid provider to source infiltration liquid (operation 1020); providing a viscous sealant supply to provide viscous sealant (operation 1030); coupling a manifold to the receiving end of the probe (operation 1040); coupling the manifold to the pressurized infiltration liquid provider and the viscous sealant supply (operation 1050); using the pressurized infiltration liquid provider to eject infiltration liquid through the manifold, into the hollow interior of the probe, and out of the probe tip (operation 1060); and using the viscous sealant supply to eject viscous sealant through the manifold, into the hollow interior of the probe, and out of the probe tip (operation 1070).

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, a system and method for repair of underground pipes using water infiltration are disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. An external underground pipe repair system comprising:
a probe with a hollow interior, the probe having a receiving end and a probe tip;
a pressurized infiltration liquid provider to source infiltration liquid;
a viscous sealant supply to provide viscous sealant;
a manifold coupled to the receiving end of the probe, the manifold also being coupled to the pressurized infiltration liquid provider and the viscous sealant supply;
the pressurized infiltration liquid provider being configured to eject infiltration liquid through the manifold, into the hollow interior of the probe, and out of the probe tip; and
the viscous sealant supply being configured to eject viscous sealant through the manifold, into the hollow interior of the probe, and out of the probe tip.

2. The external underground pipe repair system of claim 1 further including a pressurized air source configured to eject pressurized air through the manifold, into the hollow interior of the probe, and out of the probe tip.

3. The external underground pipe repair system of claim 1 further including a hollow drill bit coupled to the probe tip.

4. The external underground pipe repair system of claim 1 further including a hollow drill bit coupled to the probe tip, the probe with the coupled hollow drill bit being configured to turn about a vertical axis thereby causing the hollow drill bit to drill into intervening layers of material.

5. The external underground pipe repair system of claim 1 wherein the viscous sealant is of a type from the group consisting of: silicone foam, synthetic rubber, viscous adhesive material, and other viscous material that can seal or expand after drying.

6. The external underground pipe repair system of claim 1 wherein the viscous sealant is of a type configured to harden into a rigid, semi-rigid, foam-like, or rubber-like material with water-resistant and corrosion-resistant properties.

7. The external underground pipe repair system of claim 1 wherein the viscous sealant can be used with a catalyst.

8. The external underground pipe repair system of claim 1 wherein the probe is comprised of a plurality of attachable segments.

9. A method comprising:
providing a probe with a hollow interior, the probe having a receiving end and a probe tip;
providing a pressurized infiltration liquid provider to source infiltration liquid;
providing a viscous sealant supply to provide viscous sealant;
coupling a manifold to the receiving end of the probe;
coupling the manifold to the pressurized infiltration liquid provider and the viscous sealant supply;
using the pressurized infiltration liquid provider to eject infiltration liquid through the manifold, into the hollow interior of the probe, and out of the probe tip; and
using the viscous sealant supply to eject viscous sealant through the manifold, into the hollow interior of the probe, and out of the probe tip.

10. The method of claim 9 including providing a pressurized air source and using the pressurized air source to eject pressurized air through the manifold, into the hollow interior of the probe, and out of the probe tip.

11. The method of claim 9 including coupling a hollow drill bit to the probe tip.

12. The method of claim 9 including coupling a hollow drill bit to the probe tip and causing the probe with the coupled hollow drill bit to turn about a vertical axis thereby causing the hollow drill bit to drill into intervening layers of material.

13. The method of claim 9 wherein the viscous sealant is of a type from the group consisting of: silicone foam, synthetic rubber, viscous adhesive material, and other viscous material that can seal or expand after drying.

14. The method of claim 9 wherein the viscous sealant is of a type configured to harden into a rigid, semi-rigid, foam-like, or rubber-like material with water-resistant and corrosion-resistant properties.

15. The method of claim 9 wherein the viscous sealant can be used with a catalyst.

16. The method of claim 9 wherein the probe is comprised of a plurality of attachable segments.
